(19) United States
(12) Patent Application Publication
(10) Pub. No.: US 2007/0015085 A1
(43) Pub. Date: Jan. 18, 2007

(54) Planographic printing plate material and method of forming visible image

(76) Inventor: Tomonori Kawamura, Tokyo (JP)

Correspondence Address: CANTOR COLBURN, LLP, 55 GRIFFIN ROAD SOUTH, BLOOMFIELD, CT, 06002, US

(21) Appl. No.: 11/481,508

(22) Filed: Jul. 6, 2006

(30) Foreign Application Priority Data
Jul. 12, 2005 (JP) JP2005-202687

(51) Int. Cl. G03C 1/00

(52) U.S. Cl. 430/270.1

(57) ABSTRACT

A planographic printing plate material comprising a substrate having a hydrophilic surface and a thermosensitive image formation layer on the hydrophilic surface, the thermonsensitive image formation layer being capable of changing from hydrophilic to hydrophobic by applying heat or light, wherein an electron donating color former and a water soluble electron accepting color developer are contained in the thermosensitive image formation layer or in another layer on the hydrophilic surface.

This application is based on Japanese Patent Application No. 2005-202687 filed on Jul. 12, 2005 in Japanese Patent Office, the entire content of which is hereby incorporated by reference.

### FIELD OF THE INVENTION

The present invention relates to a planographic printing plate material and a method of forming a visible image, and specifically relates to a planographic printing plate material and a method of forming a visible image capable of forming an image according to a computer to plate (CTP) system.

### BACKGROUND OF THE INVENTION

Presently, printing employing a CTP system has been conducted in printing industries accompanied with the digitization of printing data, and desired has been a printing plate material for CTP, which is inexpensive, easy handling, and having printability comparable to that of a PS plate.

In recent years, a printing plate material has been desired which does not require any development employing a developer containing specific chemicals (such as an alkali, an acid, and a solvent), and can be applied to a conventional printing press. Known are a chemical-free type printing plate material or a processless printing plate material, for example: a phase change type printing plate material requiring no development process; a printing plate material which can be processed with water or a neutral processing liquid containing mainly of water; or a printing plate material capable of being developed in a printing press at initial stage of printing and requiring no further development process.

A printing plate material requiring no development or a processless printing plate material being developed on a printing press is required to have an exposure visualization property (meaning that the image is visualized after imagewise exposure) similarly to a conventional PS plate, since it is punched after imagewise exposure to form holes for mounting on the plate cylinder.

A processless printing plate material is imagewise exposed employing an infrared laser with an emission wavelength of from near-infrared to infrared regions to form an image. The thermal processless printing plate material employing this method is roughly classified into three types: an ablation type printing plate material, a development-on-press type printing plate material with a heat melt image formation layer, and a phase transfer type printing plate material.

As processless printing plate materials provided with a exposure-visualization property, known are the following printing plate materials:

Examples of commonly known printing plate materials include: (i) a printing plate material containing, in the image forming layer, (ia) a layer containing a thermosensitive coloring material, for example, a leuco dye and a color developing agent or (ib) a lipophilic layer containing a polymer having a functional group which generates sulfonic acid by heat and a compound of which color is changed by the generated acid (for example, refer to Patent Documents 1 and 2); (ii) a printing plate material having a layer containing an IR-dye capable of varying optical density by exposing image formation elements (for example, refer to Patent Document 3); and (iii) a printing plate material having a hydrophilic overcoat layer removable on a printing press, which contains at least 20% by weight of a cyanine infrared absorbing dye capable of varying optical density by light exposure (for example, refer to Patent Document 4).

However, since these printing plate materials contain a dye which develops color, looses color or changes color via exposure to developing light, there has been a problem that avoidance of contamination of printing ink or dampening water with the dye has not been fully easy and the number of waste sheets before obtaining satisfactory print has not been fully small, when on-press development is carried out.

Further, with respect to these printing plate materials, the sensitivity and on-press developing property of a printing plate material may become insufficient when sufficient exposure visualization is obtained, namely, it is not fully easy to balance printing suitability and exposure visualization property.

Patent Document 1 Japanese Patent Publication Open to Public Inspection (hereafter referred to as JP-A) No. 2000-225780 (Paragraph No. 0116)

Patent Document 2 JP-A No. 2002-211150 (pp. 2-15)

Patent Document 3 JP-A No. 11-240270 (pp. 3-4)

Patent Document 4 JP-A No. 2002-205466 (pp. 2-6)

### SUMMARY OF THE INVENTION

An object of the present invention to provide a planographic printing plate material and a visible image forming method by which the exposed image is easily confirmed and an excellent on-press developability is obtained.

One of the aspects of the present invention is a planographic printing plate material comprising a substrate having a hydrophilic surface and a thermosensitive image formation layer on the hydrophilic surface, the thermosensitive image formation layer being capable of changing from hydrophilic to hydrophobic by applying heat or light,

wherein an electron donating color former and a water soluble electron accepting color developer are contained in the thermosensitive image formation layer or in another layer on the hydrophilic surface.

### DESCRIPTION OF THE PREFERRED EMBODIMENTS

The above object of the present invention is achieved by the following structures.
(1) A planographic printing plate material comprising a substrate having a hydrophilic surface and a thermosensitive image formation layer on the hydrophilic surface, the thermosensitive image formation layer being capable of changing from hydrophilic to hydrophobic by applying heat or light,

wherein an electron donating color former and a water soluble electron accepting color developer are contained in the thermosensitive image formation layer or in another layer on the hydrophilic surface.
(2) The planographic printing plate material of Item (1), wherein the electron donating color former is selected from the group consisting of: crystal violet lactone; malachite green lactone; 1.3-dimethyl-6-diethylamino-fluorane; 6-diethylamino-benzo[α]-fluorane; 3-cyclohexylmethylamino-6-methyl-7-anilinofluorane; benzoyl leuco methylene blue; ethyl leuco methylene blue; methoxy benzoyl leuco methylene blue; 2-(phenylimino ethanedylidene)-3.3-trimethylindoline; 1.3.3-trimethylindolino-7'-chloro-β-naphthospiropyran; di-β-naphthospiropyran; N-acetylauramine; N-phenylauramine; and rhodamine B lactam.
(3) The planographic printing plate material of Item (1) or Item (2), wherein the water soluble electron accepting color developer is zinc salicylate.
(4) The planographic printing plate material of any one of Items (1) to (3),

wherein the electron donating color former and the water soluble electron accepting color developer are contained in a layer which is changed from hydrophilic to hydrophobic by applying heat or light.
(5) A method for forming a visible image comprising the steps of:

(i) imagewise changing the thermosensitive image formation layer of the planographic printing plate material of any one of Items (1) to (4) from hydrophilic to hydrophobic by applying heat or light;

(ii) supplying water to the thermosensitive image formation layer so as to selectively fade a color in a hydrophilic portion of the thermosensitive image forming layer.
(6) The method of Item (5), wherein the water is supplied on a printing press.

In the present invention, obtained are a planographic printing plate material and a visible image forming method by which the exposed image is easily confirmed and an excellent on-press developability is achieved.

The present invention will now be described in detail.

[Substrate]

The substrate having a hydrophilic surface of the present invention is obtained by conducting a hydrophilic treatment on the surface of the substrate or providing a hydrophilic layer on the substrate.

As the substrate of the present invention, known materials as a substrate of a printing plate are applicable.

For example, a paper material processed with, for example, a metal plate, a plastic film, polyolefine and a composite material in which above-mentioned material are appropriately pasted together are applicable. The thickness of a substrate is not specifically limited when it is capable to be installed on a printing press, however, the thickness is preferably 50-500 μm with respect to easy handling.

As a metal plate, iron, stainless steel and aluminum are employable, however, aluminum is preferable with respect to the balance specific gravity and rigidity. An aluminum plate is generally used after degreasing with, for example, an alkali, an acid, a solvent, etc., in order to remove the oil left on the surface at the time of rolling or winding in a roll. An alkaline aqueous solution is specifically preferable for degreasing treatment. Further, in order to improve adhesion with a coating layer, adhesion enhancing treatment or application of a subbing layer on the surface is preferably conducted.

There is, for example, a method in which the substrate is immersed in, or coated with, a solution containing silicate or a silane coupling agent, and then dried. Anodization treatment is considered to be one kind of the adhesion enhancing treatment and can be employed as such. Further, a combination of the anodization treatment with the immersion or coating as above can be employed. Further, an aluminum substrate which has been surface roughened according to a conventional method, a so-called grained aluminum plate, can be also employed as the substrate having a hydrophilic surface.

The aluminum substrate usable in the present invention include an aluminum plate or an aluminum alloy plate. As an aluminum alloy, there can be used various ones including an alloy of aluminum and a metal such as silicon, copper, manganese, magnesium, chromium, zinc, lead, bismuth, nickel, titanium, sodium or iron.

It is preferable that the aluminum substrate is subjected to degreasing treatment for removing rolling oil prior to surface roughening. The degreasing treatments include degreasing treatment employing solvents such as trichlene or thinner, and an emulsion degreasing treatment employing an emulsion such as kerosene or triethanol. It is also possible to use an aqueous alkali solution such as an aqueous solution of sodium hydroxide, potassium hydroxide, sodium carbonate, or sodium phosphate for the degreasing treatment. When such an aqueous alkali solution is used for the degreasing treatment, it is possible to remove stain and an oxidized film which can not be removed by the above-mentioned degreasing treatment alone.

When the aqueous alkali solution is used for the degreasing treatment, the resulting substrate is preferably subjected to neutralization treatment in an aqueous solution of an acid such as phosphoric acid, nitric acid, sulfuric acid, chromic acid or a mixed acid thereof. The electrolytic surface roughening after the neutralization is carried out preferably in the same acid solution as in the neutralization treatment.

The electrolytic surface roughening treatment of the substrate is carried out according to a known method, but prior to that, chemical surface roughening treatment of an appropriate extent and/or mechanical surface roughening treatment may be carried out.

The chemical surface roughening treatment is carried out employing an aqueous alkali solution such as an aqueous solution of sodium hydroxide,.potassium hydroxide, sodium carbonate, or sodium phosphate in the same manner as in degreasing treatment above. After that, the resulting substrate is preferably subjected to neutralization treatment in an aqueous solution of an acid such as phosphoric acid, nitric acid, sulfuric acid, chromic acid or a mixed acid thereof. The electrolytic surface roughening after the neutralization is carried out preferably in the same acid solution as in the neutralization treatment.

Though there is no limitation for the mechanical surface roughening method, a brushing roughening method and a honing roughening method are preferable.

After the substrate has been roughened mechanically, it is preferably dipped in an acid or an aqueous alkali solution in order to remove abrasives or aluminum dust, which have been embedded in the surface of the substrate or to control the shape of pits formed on the substrate surface, whereby the surface is etched. Examples of the acid include sulfuric acid, persulfuric acid, hydrofluoric acid, phosphoric acid, nitric acid and hydrochloric acid, and examples of the alkali include sodium hydroxide and potassium hydroxide.

In the present invention, the aluminum substrate was mechanically surface roughened with an abrasive with a particle size of not less than #400, followed by etching treatment employing an aqueous alkali solution, whereby a complex surface structure formed due to the mechanical surface roughening treatment can be changed to a surface having a smooth convexoconcave structure. The resulting aluminum substrate has a waviness of a relatively long wavelength of several microns to scores microns. The resulting aluminum substrate further being subjected to electrolytic surface roughening treatment described later, an aluminum substrate is obtained which provides a good printing performance and good printing durability. Further, the aluminum substrate can reduce a quantity of electricity during the electrolytic surface roughening treatment, contributing to cost reduction.

The resulting substrate after dipped in the aqueous alkali solution is preferably subjected to neutralization treatment in an aqueous solution of an acid such as phosphoric acid, nitric acid, sulfuric acid, chromic acid or the mixed acid thereof.

The electrolytic surface roughening after the neutralization is preferably carried out in the same acid solution as in the neutralization treatment.

The electrolytic surface roughening treatment in the present invention is carried out in an acidic electrolytic solution employing an alternating current. As the acidic electrolytic solution, an acidic electrolytic solution used in a conventional electrolytic surface roughening treatment can be used, but a hydrochloric acid or nitric acid electrolytic solution is preferably used. In the present invention, a hydrochloric acid electrolytic solution is specifically preferably used.

As a current waveform used in the electrolytic surface roughening treatment, various waveforms such as a rectangular wave, trapezoidal wave, sawtooth wave or sine wave can be used, but sine wave is preferably used.

Separated electrolytic surface roughening treatments disclosed in JP-A No. 10-869 are also preferably used.

In the electrolytic surface roughening treatment carried out using an electrolytic solution of nitric acid, voltage applied is preferably 1-50 V, and more preferably 5-30 V. The current density (in terms of peak value) used is preferably 10-200 A/dm², and more preferably 20-150 A/dM².

The total quantity of electricity is preferably 100-200 C/dm², more preferably 200-1500 C/dm², and most preferably 200-1000 C/dm².

Temperature during the electrolytic surface roughening treatment is preferably 10-50° C., and more preferably 15-45° C. The nitric acid concentration in the electrolytic solution is preferably 0.1-5% by weight.

It is possible to optionally add, into the electrolytic solution, nitrates, chlorides, amines, aldehydes, phosphoric acid, chromic acid, boric acid, acetic acid or oxalic acid.

The electrolytically surface roughened substrate is dipped and subjected to etching treatment in an aqueous alkali solution in order to remove smuts produced on the substrate surface, or to control the shape of pits formed on the substrate surface, whereby the surface is etched.

Examples of the alkali solution include a sodium hydroxide solution, a potassium hydroxide solution, a sodium carbonate solution, or a sodium phosphate solution.

This etching treatment improves initial printability and anti-stain property of a printing plate material comprising an image formation layer.

The resulting substrate after dipped in the aqueous alkali solution in the above is preferably subjected to neutralization treatment in an aqueous solution of an acid such as phosphoric acid, nitric acid, sulfuric acid, chromic acid, or the mixed acid thereof. The anodization treatment after the neutralization treatment is carried out preferably in the same acid solution as in the neutralization treatment.

The aluminum substrate which has been subjected to each of the surface treatments described above, followed by anodization treatment.

There is no restriction in particular for the method of anodization treatment used in the present invention, and known methods can be used. The anodization treatment forms an anodization film on the surface of the substrate. For the anodization treatment in the present invention there is preferably used a method of carrying out electrolysis by applying a current density of 1-10 A/dm² to an aqueous solution containing sulfuric acid and/or phosphoric acid in a concentration of 10-50%, as an electrolytic solution. However, it is also possible to use a method of carrying out electrolysis by applying a high current density to sulfuric acid as described in U.S. Pat. No. 1,412,768, or a method of carrying out electrolysis in phosphoric acid as described in U.S. Pat. No. 3,511,661.

The substrate, which has been subjected to anodization treatment, is optionally subjected to sealing treatment. For the sealing treatment, it is possible to use known sealing treatment carried out using hot water, boiling water, steam, an aqueous dichromate solution, a nitrite solution and an ammonium acetate solution.

The substrate subjected to anodization treatment may be subjected to surface treatment other than the sealing treatment. Examples of the surface treatment include known treatments such as silicate treatment, phosphate treatment, various organic acid treatment, PVPA treatment and boehmite treatment. Further, the substrate subjected to anodization treatment may be subjected to surface treatment disclosed in JP-A No. 8-314157 in which the substrate is treated in an aqueous bicarbonate solution or the substrate is treated in an aqueous bicarbonate solution, followed by treatment in an organic acid solution such as an aqueous citric acid solution.

Examples of a plastic film as the substrate of the present invention include polyethylene terephthalate, polyethylene naphthalate, polyimide, polyamide, polycarbonate, polysulfone, polyphenylene oxide and cellulose ester.

In order to control the lubricity of the back surface (for example, to reduce the friction factor between the surface of the plate cylinder), a substrate having a back coat layer is also preferably employable.

[Hydrophilic Layer]

A substrate having a hydrophilic surface is obtained via hydrophilic treatment of the substrate surface as described above or by providing a hydrophilic layer on the substrate.

The hydrophilic layer contains a hydrophilic material examples of which preferably include a metal oxide.

The metal oxide preferably includes metal oxide particles.

Examples of the metal oxide particles include colloidal silica, alumina sol, titania sol and sol of other metal oxide.

As morphology of the metal oxide particles, any of a spherical shape, a needle shape, a feathery shape are applicable. As a mean particle diameter, preferable is 3-100 nm, and mixed metal oxide particles of several different diameters are also applicable. The particle surface may also be subjected to a surface treatment.

Since the above oxide particles have a film forming property, these particles can also be used as a binder. The oxide particle binder is more preferable than an organic binder to be used in a hydrophilic layer, because decrease in hydrophilicity due to the use of a binder is smaller.

Among the above-mentioned hydrophilic materials, colloidal silica is specifically preferable. The colloidal silica has a high layer forming ability even when the layer is dried at a relatively low temperature, and can provide an excellent layer strength.

It is preferred that the colloidal silica used in the present invention is necklace-shaped colloidal silica or necklace-shaped colloidal silica particles having an average particle diameter of not more than 20 nm. Further, it is preferable that the colloidal solution of colloidal silica is alikaline.

The hydrophilic layer usable in the present invention preferably contains porous metal oxide particles.

As porous metal oxide particles, preferable are porous silica particles, porous alminosilicate particles or zeorite particles.

The particle diameter of porous inorganic particles is preferably 1 μm or less and more preferably 0.5 μm or less.

In the hydrophilic layer, an aqueous silicate solution may also be added as another additive. An alkali metal silicate such as sodium silicate, potassium silicate or lithium silicate is preferable, and the ratio SiO₂/M₂O is preferably selected so that the pH value of the coating liquid after addition of the silicate does not exceed 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybrid polymer by the sol-gel method.

As one of the preferable embodiments of the present invention, the hydrophilic layer may contain a light-to-heat conversion material described later.

Examples of a light-to-heat conversion material are listed below.

Examples of the infrared absorbing dye include: general infrared absorbing dyes such as, as organic dyes, a cyanine dye, a chloconium dye, a polymethine dye, an azulenium dye, a squalenium dye, a thiopyrylium dye, a naphthoquinone dye and an anthraquinone dye; and organometallic complexes such as a phthalocyanine compound, a naphthalocyanine compound, an azo compound, a thioamide compound, a dithiol compound and an indoaniline compound. Exemplarily, the light-to-heat conversion materials include compounds disclosed in JP-A Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used alone or in combination.

Also, preferably usable are the compounds disclosed in the following patent documents, for example, JP-A Nos. 11-240270, 11-265062, 2000-309174, 2002-49147, 2001-162965, 2002-144750, and 2001-219667.

With respect to the hydrophilic layer, the reflection density of visible rays at the surface is preferably 0.5 or more, and the difference in reflection density between the reflection density of the visible image providing layer of which reflection density is reduced due to exposure is preferably 0.5 or more.

(Thermosensitive Image Formation Layer)

A thermosensitive image formation layer of the present invention (hereinafter, referred to also as image formation layer) is a layer capable of forming an image via imagewise heating, which is capable of on-press developing.

In order to conduct imagewise heating, there is an image wise heating method employing a heat source directly, or a heating method via heat generated by laser light exposure. In the present invention, the image exposure method employing laser light is preferably used.

Heated portions in the image formation layer become ink receptive image portions during printing.

The image formation layer contains a thermosensitive material which deforms, melts, softens via heating.

It is one of the preferable embodiments that a light-to-heat conversion material is contained in the image formation layer.

Examples of the thermosensitive material include natural or synthetic wax, polyester, polystyrene, polyacryl, a polyurethane resin, a copolymer resin thereof, and a thermally reactive material such as block isocyanate.

In view of printing durability and on-press developability, for example, block isocyanate, a urethane resin and polyester resin particles are preferable as the thermosensitive material.

It is preferred that these resins exhibit a melting point, softening point, and a glass transition point (Tg) of 40° C. or more.

Thermoplastic resin particles are also preferably used as a thermosensitive material, and the average particle diameter is preferably 0.01-2 μm and more preferably 0.1-1 μm, in view of improving on-press developability and resolution of the image.

[Other Material Capable of Incorporation in Image Formation Layer]

In the image formation layer of the present invention, the following materials may be preferably incorporated.

Further, a water soluble resin or a water dispersible resin is preferably incorporated in the image forming layer. Examples of a water soluble resin or a water dispersible resin include: oligosaccharide, polysaccharide, polyethylene oxide, polypropylen oxide, polyvinyl alcohol, polyethylene glycols (PEG), polyvinyl ether, a conjugation diene polymer latex of methyl methacrylate-butadiene copolymer, an acrylic system polymer latex, and a methyl methacrylate butadiene copolymer, a vinyl system polymer latex, a polyacrylic acid resin, a polyacrylate resin, a polyacrylamide resin, and a polyvinyl pyrrolidone resin.

Examples of an oligosaccharide include: raffinose, trehalose, maltose, galactose, sucrose, and lactose. Of these, specifically preferable is, for example, trehalose.

Examples of a polysaccharide include: starch, cellulose, poly uronic acid, and pullulan. Specifically preferable are, for example, cellulose derivatives such as a methyl cellulose salt, a carboxymethylcellulose salt, and a hydroxyethyl cellulose salt. Still more preferable are, for example, a sodium salt and an ammonium salt of carboxymethyl cellulose.

With respect to polyacrylic acid, polyacrylate (for example, a sodium salt), and polyacrylamide, the molecular weight is preferably 3,000-5,000,000,000 and more preferably 5,000-1,000,000,000.

A water soluble resin or a water dispersible resin may be incorporated in order to decrease the background stain or to improve the durability after a long-term storage, or it may be incorporated in order to improve the on-press developability. However, when the content is increased, the durability of an image area of the printing plate may be deteriorated. Accordingly, the content is preferably minimum. The content of a water soluble resin or a water dispersible resin is preferably not more than 50% by weight and more preferably not more than 30% by weight.

A water soluble surfactant may be incorporated in the image formation layer, for example, a Si-containing surfactant, F-containing surfactant and acetylene glycol surfactant.

Further, in order to adjust the pH value, for example, an acid (such as phosphoric acid or acetic acid) or an alkaline (such as sodium hydroxide, silicate or phosphate) may be incorporated in the image formation layer.

The applied amount of the image formation layer on the printing late is preferably 0.01-10 g/m², more preferably 0.1-3 g/m² and still more preferably 0.2-2 g/m².

[Formation of Visible Image]

The planographic printing plate material of the present invention is a printing plate material containing a substrate having a hydrophilic surface, having thereon a thermosensitive image formation layer which changes from hydrophilic to hydrophobic when heat or light is irradiated, and also contains an electron donating color former and a water soluble electron accepting color developer at least in one of the constituting layers on the substrate, wherein “water soluble” means that the solubility in pure water at 20° C. is 0.5% or more.

The electron donating color former of the present invention preferably contains at least one of the following: crystal violet lactone; malachite green lactone; 1.3-dimethyl-6-diethylamino fluorane; 6-diethylamino-benzo[α]-fluorane; 3-cyclohexylmethylamino-6-methyl-7-anilino fluorane; benzoyl leuco methylene blue; ethyl leuco methylene blue; methoxy benzoyl leuco methylene blue; 2-(phenylimino ethanedylidene)-3.3-trimethylindoline; 1.3.3-trimethylindolino-7′-chloro-β-naphthospiropyran; di-β-naphthospiropyran; N-acetylauramine; N-phenylauramine; and rhodamine B lactam.

The electron accepting color developer compound used in the present invention is preferably zinc salicylate.

The electron donating color former and the water soluble electron accepting color developer compound used in the present invention are preferably contained in a layer which changes from hydrophilic to hydrophobic by applying light or heat (by energy of light or heat), whereby the coloration components (containing the electron donating color former and the water soluble electron accepting color developer compound) contained in the hydrophobic region are fixed in the layer to retain the color, while discoloration (color fading) occurs selectively in the hydrophilic region which is formed imagewise by supplying water after the formation of the hydrophobic region. Thus a visual image is formed.

(Means to Supply Water)

The means to supply water to form a visual image include, for example: non-contact or contact methods such as an inkjet method, a spray method and a felt coating method; and a method to use dampening water for printing which is carried out after imagewise formation of a hydrophobic region by applying light or heat and the printing plate is installed in a printing press.

Specific image formation method is as follows:

The thermosensitive image formation layer of the plagonographic printing plate material of the present invention is imagewise transformed from hydrophilic to hydrophobic by applying heat or light, the plagonographic printing plate material of the present invention being a planographic printing plate material containing a substrate having a hydrophilic surface and a thermosensitive image formation layer on the hydrophilic layer, which changes from hydrophilic to hydrophobic by applying heat or light, wherein one of the layer provided on the substrate contains an electron donating color former and a water soluble electron accepting color developer (which functions as a visual image providing layer). Subsequently, the plagonographic printing plate material is installed in a printing press and dampening water is supplied on the surface, whereby the color only in the hydrophilic portion of the printing plate material is faded to form a visual image.

One of the preferable embodiments of the present invention is a printing plate material containing an aluminum substrate the surface of which is subjected to a hydrophilic treatment or an aluminum substrate on which a hydrophilic layer is provided, having an image forming layer on the hydrophilic layer, wherein a light-to-heat converting material is contained in the image forming layer or in any layer on the substrate.

A layer which provides a visible image (also referred to as a visible image providing layer) is formed on the image formation layer side surface of the substrate. The visual image providing layer and the image forming layer may be different layers, however, with respect to reducing the number of layer coating steps and increasing the light-to-heat conversion efficiency, one of the preferable embodiments of the present invention is that one layer functions as both the image forming layer and the visible image providing layer.

As an upper layer of the image forming layer, a protective layer may also be provided. The material used for the protective layer is preferably a water-soluble resin or a water-dispersible resin.

Further, a hydrophilic over coat layer disclosed in, for example, JP-A Nos. 2002-019318 and 2002-086948 may also be preferably employed. The coated amount of the protective layer is preferably 0.01-10 g/m², more preferably 0.1-3 g/m² and still more preferably 0.2-2 g/m².

In the present invention, the protective layer may have the function of a visible image providing layer.

The image forming layer is a layer which is capable of carrying out on-press developing.

On-press developing means that, after the exposure, the non-image portion of the image forming layer is removed by dampening water and printing ink. The on-press developing is achieved by incorporating an above mentioned thermosensitive material, and a water soluble or a water dispersible resin in the planographic printing plate material.

After the coating liquid of a layer having both the functions of a visible image providing layer and an image forming layer is applied on a substrate having a hydrophilic surface, the applied layer is preferably dried at 20-200° C. for 10 s - 30 min, provided that the drying temperature and duration are adjusted so that the thermosensitive material does not adhere to the hydrophilic surface of the substrate, because, when the thermosensitive material is softened or melted by heat, it becomes difficult to remove from the substrate by water.

[Image Forming Method]

In the present invention, an image is formed on a printing plate material using a laser beam and preferable is an image formation using thermal laser.

For example preferable is a scanning exposure, which is carried out employing a laser emitting infrared and/or near-infrared light having a wavelength of 700-1500 nm.

As the laser, a gas laser can be used, but a semi-conductor laser, which emits light of a near-infrared region is preferably used.

A device suitable for the scanning exposure may be any device capable of forming an image on the printing plate material surface according to image signals from a computer employing the semi-conductor laser.

Generally, the following scanning exposure processes are provided.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several laser beams located inside the cylinder, while moving the lasers in the normal direction to the rotational direction of the cylinder (in the sub-scanning direction).

(3) A process in which the surface of a plate precursor provided along the outer peripheral wall of a fixed cylinder is subjected to scanning exposure in the rotational direction (in the main scanning direction) of the cylinder, employing one or several laser beams located outside the cylinder, while moving the lasers in the normal direction to the rotational direction of the cylinder (in the sub-scanning direction).

In an on-press developing printing press, the exposure process (3) is preferably employed.

[On-Press Developing Method]

Removal of unexposed portion of the image formation layer on a printing press is carried out by contacting the dampening roller and the inking roller while the plate cylinder is rotating, according to the sequence described below or according to other appropriate sequences.

The supplied amount of dampening water may be adjusted to be greater or smaller than the amount ordinarily supplied in printing, and the adjustment may be carried out stepwise or continuously.

(1) A dampening roller is brought into contact with the image formation layer of a printing plate material on the plate cylinder during one to several tens of rotations of the plate cylinder, and then an inking roller brought into contact with the image formation layer during the next one to tens of rotations of the plate cylinder. Thereafter, printing is carried out.

(2) An inking roller is brought into contact with the image formation layer of a printing plate material on the plate cylinder during one to several tens of rotations of the plate cylinder, and then a dampening roller brought into contact with the image formation layer during the next one to tens of rotations of the plate cylinder. Thereafter, printing is carried out.

(3) An inking roller and a dampening roller are brought into contact with the image formation layer of a printing plate material on the plate cylinder during one to several tens of rotations of the plate cylinder. Thereafter, printing is carried out.

### EXAMPLES

The present invention will now be described in detail referring to examples, however, the present invention is not limited thereto. Incidentally, “part” in the description represents “part by weight”, unless otherwise mentioned.

[PREPARATION OF SUBSTRATE]

A 0.24 mm thick aluminum plate (material 1050, refining H16) was immersed in an aqueous 1 by weight sodium hydroxide solution at 50° C. so as to give an aluminum dissolution amount of 2 g/m² via dissolution treatment, washed with water, immersed in an aqueous 0.1% by weight hydrochloric acid solution at 25° C. for 30 seconds to neutralize, and then washed with water.

Subsequently, the aluminum plate was subjected to an electrolytic surface-roughening treatment in an electrolytic solution containing 10 g/liter of hydrochloric acid and 0.5 g/liter of aluminum at a peak current density of 50 A/dm² employing an alternating current with a sine waveform.

The distance between the plate surface and the electrode was 10 mm in this case. The electrolytic surface-roughening treatment was divided into 12 processes, in which the quantity of electricity used in one process (at a positive polarity) was 40 C/dm², and the total quantity of electricity used (at a positive polarity) was 480 C/dm². Standby time of 5 seconds, during which no surface-roughening treatment was carried out, was provided after each of the processes of electrolytic surface-roughening treatment.

Subsequently, the resulting aluminum plate was immersed in an aqueous 1% by weight sodium hydroxide solution at 50° C. and etched to give an aluminum etching amount (including smut produced on the surface) of 1.2 g/m², washed with water, neutralized in an aqueous 10% by weight sulfuric acid solution at 25° C. for 10 seconds, and washed with water. Subsequently, the aluminum plate was subjected to anodizing treatment in an aqueous 20% by weight sulfuric acid solution at a constant voltage of 20 V, in which a quantity of electricity of 150 C/dm² was supplied, and washed with water.

The washed surface of the plate was squeegeed, and the plate was immersed in an aqueous 1% by weight sodium dihydrogen phosphate solution at 70° C. for 30 seconds, washed with water, and dried at 80° C. for 5 minutes to obtain substrate 1.

Substrate 1 had 460 nm in Ra (measured at magnification at a factor of 40, employing RST Plus, produced by WYKO Corporation).

Next, substrate 1 was immersed in an aqueous solution of 0.1% by weight ammonium acetate (produced by the Kanto chemical Co., Inc.) at 90° C for 60 seconds while stirring, followed by immersing in an aqueous solution of 0.1% by weight carboxymethyl cellulose 1150 (produced by Daicel Chemical Industries, Ltd.) at 80° C. for 30 seconds while stirring, then washed with water, and dried.

[Preparation of Planographic Printing Plate Material]

### Example 1

[Printing Plate Material 1]

A coating liquid for visible image providing-image forming layer (1) (hereinafter also referred to as image forming layer (1)) was obtained by thoroughly mixing (by stirring) the following materials, adjusting the solid content with pure water and filtering. The solid content was adjusted to 2.5% by weight.

The coating liquid was applied to the hydrophilic surface of the substrate with a wire bar so that the coated amount after dried was 0.8 g/m² followed by drying at 50° C. for 3 minutes.

An aging treatment at 35° C. for 24 hours was carried out to obtain printing plate material 1. The ratio of weight parts represents the ratio of solid substances in the layer after dried.

Coating Liquid for Image Forming Layer (1)

| | |
|---|---|
| Water-dispersible block type polyurethane | 66 parts |
| prepolymer solution (TakenateWB-700, produced | |
| by Mitsui Chemicals Polyurethanes, Inc. | |
| solid content: 44% by weight) | |
| Water-soluble resin: aqueous solution of | 5 parts |
| sodium polyacrylate, Aqualic DL522, | |
| produced by Nippon Shokubai Co., Ltd. | |
| (solid content: 5% by weight) | |
| Infrared absorbing dye: 2% by weight | 8 parts |
| isopropanol solution of ADS830AT | |
| (produced by American Dye Source, Inc.) | |
| Layered mineral particles: 5% hydrophilic | 5 parts |
| Smectite SWN aqueous solution, produced by | |
| Co-op Chemical Co., Ltd. | |
| Isopropanol solution of 2% by weight | 8 parts |
| Crystal Violet lactone | |
| Isopropanol solution of 2% by weight | 8 parts |
| zinc salicylate | |

[Image Formation via Infrared Laser Exposure]

A printing plate material was wound around an exposure drum, and fixed. Images were formed at a resolution of 2400 dpi (“dpi” means a dot number per 1 inch, i.e., 2.54 cm) and at a line number of 175 with 400 mJ/cm² of exposure energy, employing a 830 nm wave length laser with a spot diameter of 18 μm during exposure. The image pattern used for the exposure included a solid image and a dot image with a dot area of 1 to 99%.

[Formation of Visual Image]

After the exposure as described above, the surface of the printing plate was moisturized by supplying water on the image formation layer surface using a spray.

[Evaluation of Visual Image Formation]

After image formation via infrared laser exposure, a printing plate material was observed under a standard light source of Prooflite Luminaire PLD50-440 (for reflection), produced by GretagMacbeth Ltd., to observe the dot image.

Distinguishability of the difference in gradation between different dot steps was evaluated.

Evaluation Criteria

5: 5% step of dot gradation difference is visually distinguishable in a dot density range of 1-99%

4: 5% step of dot gradation difference is visually distinguishable in a dot density range of 5-95%.

3: 20% step of dot gradation difference is visually distinguishable in a dot density range of 10-90%.

2: Gradation differences between dot densities of 0% (unexposed region), 50% and 100% (solid image) are visually distinguishable.

1: Gradation difference between dot densities of 0% (unexposed region) and 100% (solid image) is visually distinguishable.

[Printing Method]

Printing was carried out employing a printing press, DAIYA 1F-1 produced by Mitsubishi Heavy Industries Ltd., accompanied with coated paper, a dampening solution of a 2% by weight solution of Astromark 3 (produced by Nikken Kagaku Kenkyusyo Co., Ltd.) and printing ink (Toyo King Hyunity Magenta, produced by Toyo Ink Manufacturing Co. Ltd.). The printing plate material was mounted on a plate cylinder of a printing press after exposure, and printing was conducted in the same initial printing sequence as in a conventional PS plate.

[Evaluation of Printing]

[On-Press Printing Property]

For each printing plate material, the number of sheets spent before on-press development was completed. When a printed sheet had no stain in non-printed area, the print density was 1.6 or more (measured at mode M using MacbethRD918) and a 95% dot image was observed to be open, development was estimated to be finished.

[Evaluation of Stain on Blanket]

At the 10th print after the development was finished, printing was stopped and the non-image portion of the blanket of the printing press was wiped with a cloth dipped in wash oil. Stain on the cloth was visually evaluated.

A: No stain was observed.

B: Slight stain was observed.

C: Blue stain from the visible image was observed.

### Example 2

Evaluation was carried out in the same manner as Example 1 except that the surface of the image forming layer of printing plate material 1 after exposure was wiped with a cellulose sponge (produced by Toray Fine Chemical Co., Ltd.) containing water to supply water on the surface, and, simultaneously, most of the image forming layer of a non-image area, namely a non-exposed area was removed.

### Example 3

Evaluation was carried out in the same manner as Example 1 except that visual image formation was confirmed as follows: printing plate material 1 just after exposure was installed in the printing press, printing was started, printing was stopped at the first printing after development was finished (the number of sheets was shown in Table 1), the ink left on the surface was removed by a cellulose sponge containing wash oil to observed the visual image formation.

Comparative 1

[Printing Plate Material 2]

Evaluation was carried out in the same manner as Example 1 except that Crystal Violet lactone and zinc salicylate were replaced with a 5% by weight aqueous solution of Food Blue No. 1: Brilliant Blue FCF (produced by Kiriya Chemical Co., Ltd.), provided that the weight ratio was adjusted to be the same as Example 1.

When printing plate material 1 was used, no stain was observed on the blanket, however, blue color was transferred to the blanket when printing plate material 2 was used.

Comparative 2

[Printing Plate Material 3]

Printing plate material 3 was obtained in the same manner as printing plate material 1 except that the isopropanol solutions of Crystal Violet lactone and zinc salicylate were not added.

When printing plate material 1 was used, the color in the non-exposed portion was faded and a visual image was observed, however, no visual image was observed, although water soaked into the non-exposed portion, when printing plate material 3 was used.

TABLE 1

| | | | Number of | |
|---|---|---|---|---|
| | Printing | Visual | sheets used | |
| | plate | Image | for on-press | Stain on |
| | material | Formation | development | blanket |
| Example 1 | 1 | 5 | 20 | A |
| Example 2 | 1 | 5 | 10 | A |
| Example 3 | 1 | 4 | 20 | A |
| Comparative 1 | 2 | 1 | 30 | C |
| Comparative 2 | 3 | 1 | 25 | A |

The results shown in Table 1 revealed that the printing plate materials of the present invention exhibit excellent on-press developability, excellent visual image distinguishability after exposure, excellent visual image formation and reduced stain on the blanket.

What is claimed is:

1. A planographic printing plate material comprising a substrate having a hydrophilic surface and a thermosensitive image formation layer on the hydrophilic surface, the thermosensitive image formation layer being capable of changing from hydrophilic to hydrophobic by applying heat or light,
wherein an electron donating color former and a water soluble electron accepting color developer are contained in the thermosensitive image formation layer or in another layer on the hydrophilic surface.

2. The planographic printing plate material of claim 1,
wherein the electron donating color former is selected from the group consisting of: crystal violet lactone; malachite green lactone; 1.3-dimethyl-6-diethylamino-fluorane; 6-diethylamino-benzo[α]-fluorane; 3-cyclohexylmethylamino-6-methyl-7-anilinofluorane; benzoyl leuco methylene blue; ethyl leuco methylene blue; methoxy benzoyl leuco methylene blue; 2-(phenylimino ethanedylidene)-3.3-trimethylindoline; 1.3.3-trimethylindolino-7'-chloro-β-naphthospiropyran; di-β-naphthospiropyran; N-acetylauramine; N-phenylauramine; and rhodamine B lactam.

3. The planographic printing plate material of claim 1,
wherein the water soluble electron accepting color developer is zinc salicylate.

4. The planographic printing plate material of claim 1,
wherein the electron donating color former and the water soluble electron accepting color developer are contained in a layer which is changed from hydrophilic to hydrophobic by applying heat or light.

5. A method for forming a visible image comprising the steps of:
(i) imagewise changing the thermosensitive image formation layer of the planographic printing plate material of claim 1 from hydrophilic to hydrophobic by applying heat or light;
(ii) supplying water to the thermosensitive image formation layer so as to selectively fade a color in a hydrophilic portion of the thermosensitive image forming layer.

6. The method of claim 5, wherein the water is supplied on a printing press.
